(19) United States
(12) Patent Application Publication
(10) Pub. No.: US 2006/0274797 A1
(43) Pub. Date: Dec. 7, 2006

(54) Method for cooling semiconductor diodes and light emitting diodes

(75) Inventors: Jeffrey A. Myers, Hilton Head, SC (US); John D. Myers, Hilton Head, SC (US); Michael J. Myers, Hilton Head, SC (US); Baoping Guo, Hilton Head, SC (US)

Correspondence Address: DICKINSON WRIGHT PLLC, 38525 WOODWARD AVENUE, SUITE 2000, BLOOMFIELD HILLS, MI, 48304-2970, US

(73) Assignee: Kigre, Inc., Hilton Head, SC (US)

(21) Appl. No.: 11/448,441

(22) Filed: Jun. 7, 2006

Related U.S. Application Data
(60) Provisional application No. 60/688,251, filed on Jun. 7, 2005.

(51) Int. Cl. H01S 3/04

(52) U.S. Cl. 372/35; 372/36

(57) ABSTRACT

A relatively simple and inexpensive method to increase the operational lifetime of semiconductor laser diode elements and light emitting diodes (LEDs) is disclosed. The semiconductor laser diode element is placed in contact with a non-electrically conductive, chemically inert liquid. Preferably the liquid is a perfluorinated liquid. This results in a dramatically increased operational lifetime for the semiconductor laser diode element by preventing damaging heat build up to vulnerable areas of the laser diode element, such as the p-n junction. This method can work with the liquid being either static or flowing. The disclosed method can be used when the semiconductor laser diode element is used either as a laser itself or when it is used to optically pump another lasing element. The liquid can also be in contact with the lasing element, collimating lens, sub-mounts, or thermoelectric coolers in a lasing assembly. In a similar manner the operational lifetime and the range of power usage of an LED can be dramatically increased by placing the LED in contact with the non-electrically conductive, chemically inert liquid. Preferably the liquid is a perfluorinated liquid. The liquid can either be static or flowing. It is anticipated that this improvement will permit high power applications such as vehicle headlights to become powered by LEDs.

### RELATED APPLICATIONS

This application claims priority to U.S. Provisional Patent Application Ser. No. 60/688,251 filed on Jun. 7, 2005.

### STATEMENT REGARDING FEDERALLY SPONSORED RESEARCH

NONE

### TECHNICAL FIELD

This invention relates generally to semiconductor diodes and, more particularly, to a method for cooling semiconductor laser diode elements that are used as lasers or in lasers and for cooling semiconductor light emitting diodes to prolong their effective life.

### BACKGROUND OF THE INVENTION

Semiconductor diode elements are used in a variety of applications across research and industry. Semiconductor diode elements are used as single diodes or in the form of bars having several diodes in each bar. These semiconductor diode elements can be used as laser diodes in lasers to either end pump or side pump the actual laser element. Highly efficient semiconductor laser diodes have been developed that are capable of serving as the laser themselves rather than just as an optical pump to drive a lasing element in a laser system. These are called semiconductor laser diodes since it is the semiconductor p-n junction itself that serves as the active medium of the laser. When used as the laser itself the semiconductor laser diode element is designed to have two facets that act as the mirrors with the other facets being disrupted by etching, sawing, grinding or other means to prevent spurious laser modes. A primary failure mechanism of semiconductor laser diode elements, both bars and single emitters whether as lasers or optical pumps, is the build up of heat in areas such as the p-n junction. Historically, heat sinks or sub-mounts made of metals, ceramic, diamond, beryllium, sapphire or mixtures thereof have been used to mount the semiconductor laser diode elements, thereby providing some heat relief. In addition, thermo-electric coolers have been used in combination with the heat sink/sub-mounts to conductively cool the laser diode element. Even with these cooling methods the lifetime of semiconductor laser diode elements can be limited due to thermal failure. Common wisdom dictates that the semiconductor laser diode element be kept in pristine air only, to prevent contamination of the laser diode element or the lasing element and the subsequent failure.

Another common type of semiconductor laser diode is the light emitting diode (LED). An LED also relies on a p-n junction to cause the light and is surrounded by a housing that is transparent to the emitted light. The power output from LEDs has been quite low in the past because if they are driven by too high a current the diode will fail by melting. This has limited the usefulness of LEDs to low power applications such as indicator lights, remote controls and other low power applications. New uses of LEDs include their use in vehicle headlights and other high intensity environments. Such applications may require the LEDs to be driven at much higher current than in the past thereby increasing the need to develop a way to cool the LED.

Direct cooling of the most sensitive areas of the semiconductor laser diode element or an LED with a liquid has been avoided in the past because of the fear of causing electrical arcs within the semiconductor laser diode element or the LED. The use of a liquid coolant directly on the semiconductor laser diode element or LED also raised fears of introducing contaminants into the system that would decrease the operational lifetime or even cause catastrophic failure of the semiconductor laser diode element or LED.

### SUMMARY OF THE INVENTION

In general terms, this invention provides a method for dramatically increasing the lifetime of semiconductor laser diode elements used as lasers or in lasers or the lifetime of LEDs, especially in high power usage applications. In one embodiment the semiconductor laser diode element is placed in contact with a non-electrically conductive, chemically inert liquid, preferably a perfluorinated liquid. This has been shown to dramatically increase the operational lifetime of the semiconductor laser diode element by orders of magnitude without negatively affecting the laser diode's operational characteristics. Likewise the lifetime of high power LEDs can be increased by placing the LED in contact with a non-electrically conductive, chemically inert liquid, preferably a perfluorinated liquid.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 is a cross-sectional schematic side view of a laser assembly side pumped with a semiconductor laser diode element designed according to the present invention;

FIG. 2 is a cross-sectional schematic side view of a laser diode assembly designed according to the present invention;

FIG. 3 is a cross-sectional schematic side view of another embodiment of a laser assembly side pumped with a semiconductor laser diode element designed according to the present invention;

FIG. 4 is a cross-sectional schematic side view of laser assembly end pumped with a semiconductor laser diode element designed according to the present invention; and

FIG. 5 is a cross-sectional schematic view of a light emitting diode designed according to the present invention.

### DETAILED DESCRIPTION OF A PREFERRED EMBODIMENT

As discussed above the semiconductor laser diode elements of the present invention may be formed to function as stand alone lasers, as optical pumps to drive other lasing elements, or as LEDs. Each of these systems will be described below.

FIG. 1 is a cross-sectional schematic side view of a laser assembly 10 side pumped by a semiconductor laser diode element 18 designed according to the present invention. The assembly 10 includes an outer casing 12 that can be formed from a variety of materials. Preferably the casing 12 is formed from gold plated copper. Within casing 12 are a plurality of heat sink sub-mounts 16. Preferably, at least one of the sub-mounts 16 is mounted to a thermo-electric cooler 24. A semiconductor laser diode element 18 is mounted on each sub-mount 16. Preferably the laser diode element 18 is a bar element containing a plurality of laser diodes in it. The power supply to the laser diode element 18 is not shown for clarity and those of ordinary skill in the art understand that the power supply can be one of many typical power supplies. Those of ordinary skill in the art will understand that the laser diode element 18 can be secured to the sub-mount 16 in a variety of ways depending on the sub-mount 16 material. A collimating lens 20 is positioned between each laser diode element 18 and a lasing element 22. The lasing element 22 is any typical lasing element 22 such as a glass or crystalline material doped with one or more rare earth elements such as: cerium, praseodymium, neodymium, promethium, samarium, europium, gadolinium, terbium, dysprosium, holmium, erbium, thulium, ytterbium, lutetium, copper, chromium, and combinations thereof. In this embodiment the lasing element 22 extends out of both sides of casing 12 and seals 34 are located at the points where the lasing element 22 exits the casing 12.

A non-electrically conductive, chemically inert liquid 14 is place in contact with at least the semiconductor laser diode element 18. It is preferable that the liquid 14 be optically transparent to the desired wavelength from the laser diode element 18. The amount of transmission of the desired wavelength through the liquid 14 is dependent on the environment that the laser diode element 18 is used in. In some environments, for example, it may be tolerable to have only 10% transmittance through the liquid 14. In other enviroments it may be required to have a higher efficiency such as 90% or more transmittance. The key factor is that the liquid 14 be in contact with the laser diode element 18 and that it provide cooling of the element 18 to prolong its useable life relative to not having the liquid 14. By optically transparent it is meant that the liquid 14 allows at least a portion of the desired wavelength of the laser diode element 18 to pass through it. In one embodiment, the liquid 14 floods the entire interior of the casing 12, in another embodiment the liquid 14 is kept from contacting the lasing element 22 and the collimating lenses 20 by a glass enclosure 32. Preferably the liquid 14 is also transparent to the human eye and to the lasing element's emitted light wavelength if the lasing element 22 is surrounded by the liquid 14. It is believed that any non-electrically conductive, chemically inert liquid 14 will work provided it can dissipate heat. Preferred liquids 14 are perfluorinated liquids 14. Preferably alkyl or polyalkyl perfluorinated liquids 14. Examples include perfluorinated polyethers such as the Gladen liquids available from Kurt J. Lesker Company. Other examples include the Fluorinert™ brand liquids available from 3M. These liquids are C₅ to C₁₈ fully fluorinated liquids. Other examples include the Krytox® 143 series available from DuPont, which are perfluoroalkylethers or perfluoropolyalkylethers. The liquid 14 can either be static in casing 12 or casing 12 may include liquid inlets 36 and liquid outlets 38 thereby permitting flow of the liquid 14 through the casing 12. The liquid 14 can then be routed through a heat exchanger, not shown, to cool the liquid 14. If the liquid 14 is circulated it can also be passed through a filter element, not shown, to remove any contaminates that develop during use.

Optionally, casing 12 may include a glass enclosure 32 surrounding the collimating lenses 20 and the lasing element 22 to prevent contact of the liquid 14 with these elements. As noted above, this embodiment uses the laser diode element 18 to side pump the lasing element 22. The assembly 10 further includes an output coupler, Q switch 28 and an HR mirror 30 as in any standard laser. Such elements are well know to those of ordinary skill in the art and will not be explained further. One advantage of the assembly 10 shown in FIG. 1 is that the refractive index of the liquid 14 does not effect the output of the lasing element 22 because the ends of the lasing element 22 are located outside the casing 12, therefore the beam emitted by the lasing element 22 does not travel through the liquid 14.

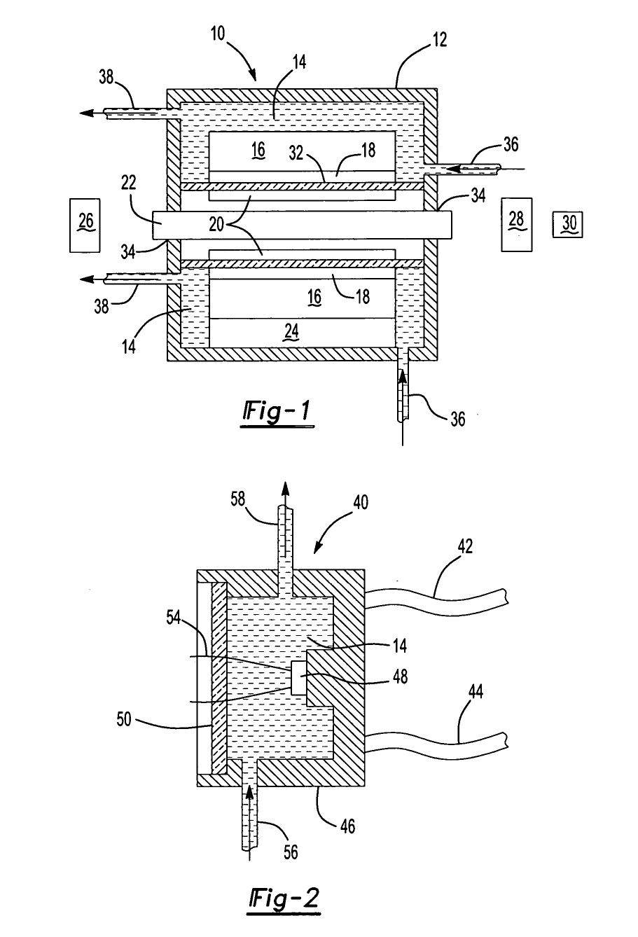

In FIG. 2 a semiconductor laser diode assembly is shown generally at 40. The assembly 40 includes an outer casing 46. Within the casing 46 at least one semiconductor laser diode element 48 is mounted. In this embodiment the semiconductor laser diode element 48 is the laser itself. The laser diode element 48 may also comprise a plurality of laser diode elements 48 in a stripe formation as described above. An optical window or lens 50 is located opposite the laser diode element 48 and allows the output 54 to exit the casing 46. Electrical leads 42, 44 power the laser diode element 48. The casing 46 is filled with a non-electrically conductive, chemically inert liquid 14 as described above. Optionally, a liquid input 56 and liquid output 58 can be used to circulate the liquid 14 through the casing 46 and a heat exchanger and/or filter element, not shown. The liquid 14 can also be used in a static mode as described above.

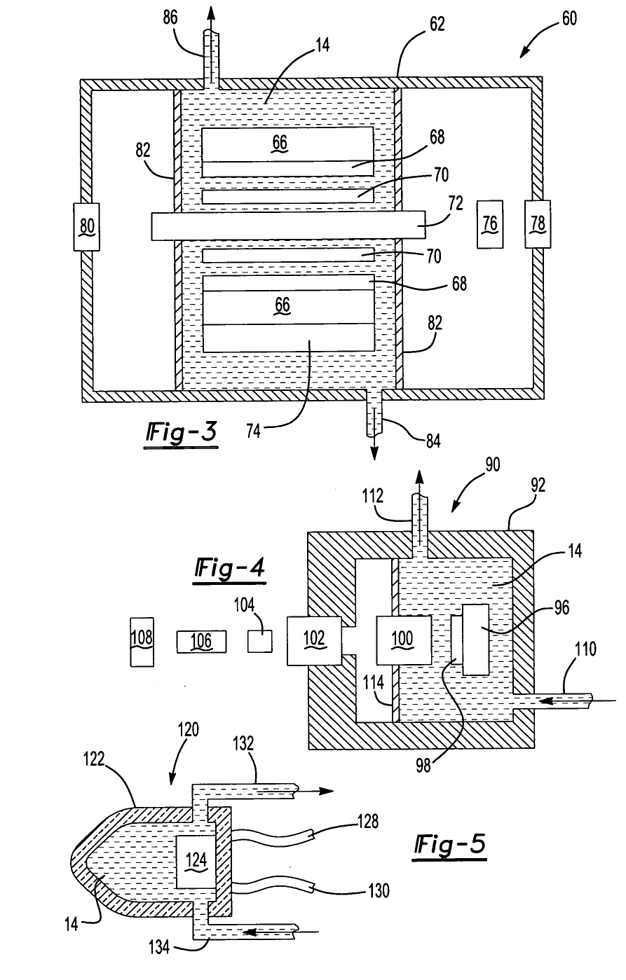

In FIG. 3 a side pumped laser assembly is shown generally at 60. This embodiment is similar to that shown in FIG. 1 with the difference being that a lasing element 72, output coupler 80, Q switch 76 and HR mirror 78 are in contact with the non-electrically conductive, chemically inert liquid 14 as described above. The assembly 60 includes an outer casing 62 that surrounds an optional thermo-electric cooler 74, a plurality of sub-mounts 66 each of which has mounted thereto a semiconductor laser diode element 68. A collimating lens 70 is located between each laser diode element 68 and the lasing element 72. Optionally, the assembly 60 may also include an enclosure 82 surrounding the collimating lenses 70 and at least a portion of the lasing element 72. This enclosure 82 does not need to be glass. If the enclosure 82 is used then the fluid 14 will not contact the ends of the lasing element 72, output coupler 80, Q switch 76 and HR mirror 78. The advantage of the enclosure 82 is that the refractive index of the fluid does not have to be taken into account in designing the assembly 60. Casing 62 may also optionally include a liquid input 84 and an output 86 to permit flow of the liquid 14 through a heat exchanger and/or filter element, not shown. As noted above the liquid 14 may also be static in casing 62. In the embodiment without the enclosure 82 the refractive index of the liquid 14 requires the output coupler 80, Q switch 76, and HR mirror 78 be modified from those shown in FIG. 1, as is know to those of ordinary skill in the art, since the output from the lasing element 72 will travel through the liquid 14. Also the liquid 14 is then preferably optically transparent to the output of the lasing element 72.

In FIG. 4 a cross-sectional schematic view of an end pumped laser assembly is shown generally at 90. The assembly 90 includes an outer casing 92 which encloses a non-electrically conductive, chemically inert liquid 14 as described above. A heat sink sub-mount 96 is located in the casing 92. Although not shown for clarity, the sub-mount 96 could also be mounted to a thermo-electric cooler as shown in FIG. I above. A semiconductor laser diode element 98 is mounted to the sub-mount 96. Casing 92 further includes an optical element 100 which acts as a collimating lens for the output of the laser diode element 98. The laser diode element 98 may be formed from a plurality of laser diodes or from a single laser diode as the situation dictates and as would be understood by one of ordinary skill in the art. In this embodiment the output from the optical element 100 passes through an HR mirror 102, Q switch 104, a lasing element 106, and an output coupler 108. These elements are standard to any laser and will not be discussed further other than to note that the Q switch 104 could also be located between the lasing element 106 and the output coupler 108. In addition, like shown above in FIG. 3 the casing 92 could be expanded to include any or all of the Q switch 104, the lasing element 106, and/or the output coupler 108. The advantage of the system 90 as shown in FIG. 4 is again that the output from the lasing element 106 does not pass through the liquid 14 and thus its refractive index does not have to be accounted for. Assembly 90 can further include a liquid inlet 110 and a liquid outlet 112 to allow for circulation of liquid 14 through a heat exchanger and/or filter element, not shown, if desired as described above. In addition, if desired an enclosure 114 can be used to keep the liquid 14 from contacting an end of the optical element 100 and the HR mirror 102.

As discussed above, the present invention also finds use in LED applications. An LED assembly is shown generally at 120 in FIG. 5. The assembly 120 includes an outer casing 122 that is transparent to the emitted light and enclosing a semiconductor LED 124. The outer casing 122 contains a non-electrically conductive, chemically inert liquid 14 as described above in direct contact with the LED 124. A pair of electrical leads 128, 130 to power the LED 124 are shown. As above the casing 122 may include a liquid inlet 134 and a liquid outlet 132 to permit circulation of the liquid 14 through a heat exchanger and/or filter element, not shown. The embodiment shown in FIG. 5 is believed to show promise in the area of high intensity LED applications such as vehicle headlights. Again, it is desirable that the liquid 14 be minimally absorbant of the desired wavelength of light as dictated by the environment of the LED 124. Although not shown, the semiconductor LED could be mounted to a sub-mount 16 which is in turn optionally connected to a thermo-electric cooler 24.

The value of the non-electrically conductive, chemically inert liquid 14 of the present invention to enhance the operational lifetime of semiconductor laser diode elements is shown in the following experiment. A pair of 50 W Quasi-CW 940 nanometer stripe semiconductor laser diode elements 18 were each attached to a sub-mount 16 by conventional means as purchased from an industry manufacturer. Each of the sub-mounted laser diode elements 18 were then attached to a thermoelectric cooler 24 by conventional means. One of the laser diode elements 18 was then placed into a control copper casing 12 and attached to a power supply by conventional means. A mirror was placed at a 45 degree angle relative to the face of the stripe laser diode element 18 to reflect the output of the stripe laser diode element 18 into an energy meter detector. Thus, the energy output of the stripe laser diode element 18 could be measured over time. The control casing 12 contained only air in contact with the stripe laser diode element 18 as per industry standard. A test casing 12 was designed the same as the control casing 12 however it was filled with a non-electrically conductive, chemically inert, perfluorinated liquid 14, Gladen from Kurt J. Lesker, which is transparent at 940 nanometers, rather than air. Both power supplies were set for amperage of 80 amperes with a pulse width of 3 milliseconds, and a repetition rate of 10 hertz. The temperatures of the sub-mounts 16 were kept at 16 degrees Celsius in both the control and the test casing 12 with the use of the coolers 24. As those of ordinary skill in the art will recognize, these values were chosen for the particular application of side pumping of erbium doped glass lasers by semiconductor laser diode elements where it has proven to be quite difficult for Quasi-CW laser diode elements 18 to maintain an adequate lifetime, due to the relatively long pulse width specification.

The laser diode elements 18 in the casing 12 containing only air suffered failure after less than 220,000 shots, approximately 5.5 hours. At that point in the experiment the energy output dropped precipitously to less than half of the initial output. By way of contrast, the laser diode elements 18 in the casing 12 with the perfluorinated liquid 14 continued working past 2,200,000 shots, over 55 hours continuously, with no degradation in energy output. Thus, the use of the non-electrically conductive, chemically inert liquid 14, preferably of a perfluorinated type, dramatically increases the operational life of semiconductor laser diode elements 18 even when held static. It is anticipated that similar results can be obtained in high power LED applications such as headlights. This result goes against conventional wisdom, which teaches that the semiconductor laser diode element should be kept in a pristine state in the clean air to prevent failure and to maintain operational life.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A laser diode assembly comprising a non-electrically conductive chemically inert liquid in direct contact with a semiconductor laser diode element.

2. A laser diode assembly as recited in claim 1 wherein said liquid comprises a perfluorinated liquid.

3. A laser diode assembly as recited in claim 2 wherein said perfluorinated liquid comprises an alkyl or polyalkyl perfluorinated liquid.

4. A laser diode assembly as recited in claim 2 wherein said perfluorinated liquid is selected from the group consisting of a liquid perfluorinated polyether, a fully fluorinated C₅ to C₁₈ liquid, a liquid perfluoroalkylether, a perfluoropolyalkylether, or mixtures thereof.

5. A laser diode assembly as recited in claim I wherein said liquid is in static direct contact with said semiconductor laser diode element.

6. A laser diode assembly as recited in claim 1 wherein said liquid is in direct contact with said semiconductor laser diode element and said liquid flows around said semiconductor laser diode element.

7. A laser diode assembly as recited in claim 6 further comprising a heat exchanger with said liquid circulating through said heat exchanger and flowing around said semiconductor laser diode element.

8. A laser diode assembly as recited in claim 1 further comprising a sub-mount in contact with a thermo-electric cooler and with said semiconductor laser diode element mounted onto said sub-mount.

9. A laser diode assembly as recited in claim 1 further comprising a lasing element with said semiconductor laser diode element optically connected to said lasing element and with said semiconductor laser diode element optically pumping said lasing element.

10. A laser diode assembly as recited in claim 9 wherein said liquid is in direct contact with said lasing element.

11. A laser diode assembly as recited in claim 1 wherein said semiconductor laser diode element is a lasing element.

12. A light emitting diode assembly comprising a non-electrically conductive chemically inert liquid in direct contact with a semiconductor light emitting diode.

13. A light emitting diode assembly as recited in claim 12 wherein said liquid comprises a perfluorinated liquid.

14. A light emitting diode assembly as recited in claim 13 wherein said perfluorinated liquid comprises an alkyl or polyalkyl perfluorinated liquid.

15. A light emitting diode assembly as recited in claim 13 wherein said perfluorinated liquid is selected from the group consisting of a liquid perfluorinated polyether, a fully fluorinated C₅ to C₁₈ liquid, a liquid perfluoroalkylether, a perfluoropolyalkylether, or mixtures thereof.

16. A light emitting diode assembly as recited in claim 12 wherein said liquid is in static direct contact with said semiconductor light emitting diode.

17. A light emitting diode assembly as recited in claim 12 wherein said liquid is in direct contact with said semiconductor light emitting diode and said liquid flows around said semiconductor light emitting diode.

18. A light emitting diode assembly as recited in claim 17 further comprising a heat exchanger with said liquid circulating through said heat exchanger and flowing around said semiconductor light emitting diode.

19. A light emitting diode assembly as recited in claim 12 further comprising a sub-mount in contact with a thermo-electric cooler and with said semiconductor light emitting diode mounted onto said sub-mount.

20. A method of cooling a semiconductor laser diode element comprising the steps of:
a) providing a semiconductor laser diode element;
b) providing a non-electrically conductive chemically inert liquid; and
c) placing the liquid in direct contact with the semiconductor laser diode element, the liquid thereby able to cool the diode element.

21. The method as recited in claim 20 wherein step b) comprises providing a perfluorinated liquid.

22. The method as recited in claim 21 wherein step b) comprises providing an alkyl or polyalkyl perfluorinated liquid.

23. The method as recited in claim 21 wherein step b) comprises providing a perfluorinated liquid selected from the group consisting of a liquid perfluorinated polyether, a fully fluorinated C₅ to C₁₈ liquid, a liquid perfluoroalkylether, a perfluoropolyalkylether, or mixtures thereof.

24. The method as recited in claim 20 wherein step c) comprises placing the liquid in static direct contact with the semiconductor laser diode element.

25. The method as recited in claim 20 wherein step c) further comprises flowing the liquid around the semiconductor laser diode element.

26. The method as recited in claim 25 wherein step c) further comprises providing a heat exchanger and circulating the liquid through the heat exchanger and flowing the liquid around the semiconductor laser diode element.

27. The method as recited in claim 20 wherein step a) further comprises providing a sub-mount in contact with a thermo-electric cooler and mounting the semiconductor laser diode element onto the sub-mount.

28. The method as recited in claim 20 further comprising the step of providing a lasing element and optically connecting the semiconductor laser diode element to the lasing element with the semiconductor laser diode element optically pumping the lasing element.

29. The method as recited in claim 28 comprising the further step of placing the liquid in direct contact with the lasing element.

30. The method as recited in claim 20 wherein step a) further comprises providing the semiconductor laser diode element as a lasing element.

31. A method of cooling a semiconductor light emitting diode comprising the steps of:
a) providing a semiconductor light emitting diode;
b) providing a non-electrically conductive chemically inert liquid; and
c) placing the liquid in direct contact with the semiconductor light emitting diode, the liquid thereby able to cool the diode.

32. The method as recited in claim 31 wherein step b) comprises providing a perfluorinated liquid.

33. The method as recited in claim 32 wherein step b) comprises providing an alkyl or polyalkyl perfluorinated liquid.

34. The method as recited in claim 32 wherein step b) comprises providing a perfluorinated liquid selected from the group consisting of a liquid perfluorinated polyether, a fully fluorinated C₅ to C₁₈ liquid, a liquid perfluoroalkylether, a perfluoropolyalkylether, or mixtures thereof.

35. The method as recited in claim 31 wherein step c) comprises placing the liquid in static direct contact with the semiconductor light emitting diode.

36. The method as recited in claim 31 wherein step c) further comprises flowing the liquid around the semiconductor light emitting diode.

37. The method as recited in claim 36 wherein step c) further comprises providing a heat exchanger and circulating the liquid through the heat exchanger and flowing the liquid around the semiconductor light emitting diode.

38. The method as recited in claim 31 wherein step a) further comprises providing a sub-mount in contact with a thermo-electric cooler and mounting the semiconductor light emitting diode onto the sub-mount.
